(19) United States
(12) Patent Application Publication
(10) Pub. No.: US 2026/0237129 A1
(43) Pub. Date: Aug. 13, 2026

(54) PRESENTATION OF QUANTITATIVE MISMATCH BETWEEN ACQUIRED DATA SET AND DATA MODEL

(71) Applicant: Siemens Medical Solutions USA, Inc., Malvern, PA (US)

(72) Inventors: Alexander Hans Vija, Evanston, IL (US); Francesc dAssis Massanes Basi, Chicago, IL (US); Kevin Scott Hakl, Barrington, IL (US)

(21) Appl. No.: 19/157,443

(22) PCT Filed: May 18, 2023
(86) PCT No.: PCT/US2023/067155

§ 371 Date: Aug. 18, 2025

(51) Int. Cl. G06T 12/20; G06T 5/50

(52) U.S. Cl. CPC G06T 12/20; G06T 5/50; G06T 2207/20221; G06T 2207/20224

(57) ABSTRACT

A system and method includes identification of a first plurality of projection images of an object acquired by an imaging system, each of the first projection images associated with a respective one of a plurality of projection angles, reconstruction of a three-dimensional image of the object based on the first projection images, forward-projection of the three-dimensional image at the plurality of projection angles to generate second projection images, each of the second projection images associated with a respective one of the projection angles, determination of a first CDF image for a first one of the projection angles based on a first one of the first projection images a second one of the second projection images, determination of pixels of the first CDF image corresponding to differences, and combination of the determined pixels with the first one of the first projection images to generate a first combined image.

### BACKGROUND

Tomographic reconstruction technology enables three-dimensional imaging of volumes for a variety of applications. In some nuclear imaging applications, a radioactive substance is administered to a patient, and resulting y-radiation emitted from the patient is detected with a detector system. A data set representing the detected y-radiation is provided to a tomographic reconstruction unit, which computes an image object, e.g., a three-dimensional (3D) image object, based on the data set.

The occurrence of various phenomena (e.g., motion, tomographic inconsistency, breathing) during radiation detection may result in an image object which includes blurring, artifacts, excessive noise, etc. Accordingly, modern tomographic reconstruction often includes corrective algorithms to address such phenomena. These algorithms do not alter the data set itself, but rather the data model which is used to generate the image object during the iterative tomographic reconstruction process as is known in the art.

As described in U.S. Pat. No. 8,674,315, the modified cumulative distribution function (MCDF) image is the spatial distribution of the underfitting and overfitting between the image object reconstructed from the data model and the acquired data set given the noise in the data. If the data sets and the data model were fully consistent with one another, the MCDF image would consist of white noise. A MCDF image including dark areas or bright areas (i.e., valleys and peaks, respectively) is indicative of underfitting/overfitting due to the data model.

The MCDF image is therefore also indicative of the extent to which the data set was corrected by the correction algorithms of the reconstruction process. The extent may be captured as a numerical value (i.e., a MCDF deviation score) determined based on the deviation inside the peaks and valleys of the MCDF image with respect to the overall deviation of the MCDF image.

Systems are desired to efficiently present underfitting/overfitting caused tomographic reconstruction of the data set based on a data model, in a manner facilitating a user's understanding of the underfitting/overfitting.

### BRIEF DESCRIPTION OF THE DRAWINGS

FIG. 1 is a block diagram of a system to present quantitative mismatches between an acquired tomographic data set and a data model represented by a reconstructed image object according to some embodiments;

FIG. 2 is a flow diagram of a process to present quantitative mismatches between an acquired tomographic data set and a data model represented by a reconstructed image object according to some embodiments;

FIG. 3 illustrates generation of data projections from a reconstructed image object according to some embodiments;

FIG. 4 illustrates generation of combined data projections from acquired data projections and overlay images determined from MCDF images according to some embodiments;

FIG. 5 is a view of an acquired projection image according to some embodiments;

FIG. 6 is a view of an MCDF image determined based on the acquired projection image of FIG. 5 and a corresponding data projection according to some embodiments;

FIG. 7 is a view showing pixels associated with data mismatches determined from the FIG. 6 MCDF image according to some embodiments;

FIG. 8 is a view of a combination of the FIG. 5 acquired data projection and the determined pixels of FIG. 7 according to some embodiments; and

FIG. 9 is a view of an imaging system according to some embodiments.

### DETAILED DESCRIPTION

The following description is provided to enable any person in the art to make and use the described embodiments and sets forth the best mode contemplated for carrying out the described embodiments. Various modifications, however, will remain apparent to those in the art. Independent of the grammatical term usage, individuals with male, female or other gender identities are included within the term.

Some embodiments facilitate comparison between an acquired data set of projection images used to reconstruct an image object and a data model of the reconstructed image object. The data model is represented by a plurality of projection images of the reconstructed image object at various projection angles. For each projection angle, a cumulative distribution function is used to generate a representation of differences between each projection image of the data model and its corresponding acquired projection image. This representation may be overlaid on its corresponding acquired projection image to efficiently present quantitative mismatches between the acquired data and the data as represented by the reconstructed image object. In a case that reconstruction of the image object included corrective algorithms, the overlaid image may efficiently illustrate the impact of the corrections on the data model.

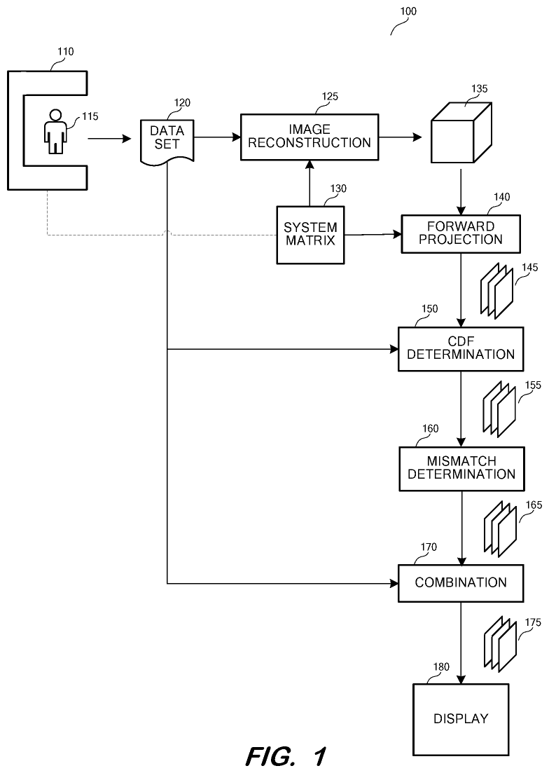

FIG. 1 illustrates system 100 according to some embodiments. Each component of system 100 and each other component described herein may be implemented using any combination of hardware and/or software. Some components may share hardware and/or software of one or more other components.

System 100 includes imaging system 110. Imaging system 110 is not limited to any particular imaging modality. For example, imaging system 110 may comprise a single-photon emission computed tomography (SPECT) system, a positron emission tomography (PET) system, a computed tomography (CT) system, or any other system for generating tomographic images of a subject 115 that is or becomes known.

In the case of a conventional SPECT or PET system, a radioactive substance is administered to subject 115 and imaging system 110 detects y-radiation emitted from subject 115 (e.g., using a ring detector in the case of PET imaging and one or several gamma cameras for SPECT imaging). The detected y-radiation is represented within data set 120 in any suitable format known in the art. Data set 120 may comprise a set of projection images (i.e., two-dimensional images associated with respective projection angles showing a spatial distribution of photons detected at each angle), list mode data, sinograms, etc.

Image reconstruction component 125 calculates image object 135 based on data set 120. As described herein, an “image object” is defined in an object space and is a reconstruction of a data set acquired in a data space. The object space is a space in which the result of image reconstruction is defined and which corresponds to subject 115 that was imaged using imaging system 110.

Object space and data space are related to each other through imaging system 110 and this relation is modeled by system matrix 130. System matrix 130 describes the data acquisition properties of imaging system 110. As is known in the art, image reconstruction component 125 uses system matrix 130 and an iteratively-improved data model to calculate image object 135. Image object 135 may be an N-dimensional image object (typically N=3 in medical imaging applications) and may be displayed to a user using known volume rendering techniques.

Image reconstruction component 125 may implement any known tomographic reconstruction algorithm, such as but not limited to an algorithm described in U.S. Pat. Pub. No. 2008/0270465, “NNLS Image Reconstruction” by Vija et al., or U.S. Pat. Pub. No, 2009/0110255, “Reconstructing a Tomographic Image” by Vija et al., the contents of which references are incorporated herein in their entirety. Data sets acquired using PET and SPECT imaging modalities may include a low number of radiation counts and an unavoidable noise contribution. Some tomographic reconstruction algorithms are especially suited for reconstructing an object from such data sets.

Forward projection component 140 forward-projects image object 135 into data space. Forward-projection component 140 generates a plurality of two-dimensional images 145 in data space, where each of the images 145 represents a forward-projection of image object 135 at a particular projection angle. The plurality of two-dimensional images 145 generated by forward projection component 140 thereby represent a data model underlying image object 135, i.e., a data set which, when reconstructed into object space, should result in image object 135.

Forward projection component 140 uses the system matrix 130 to transform objects from object space and data space. A forward projection projects an object I_{object} from object space into data space to yield a data model M_{data} of the input object I_{object}. In particular, a sum of projections of an image object I_{object} into data space at several projection angles results in a data model Mᵢ of that estimated image:

$${M}_{i} = {\sum }_{α} {H}_{i α} {I}_{α}$$

where α represents a projection angle and H_{iα} represents a system matrix for angle α.

CDF determination component 150 determines images 155 based on images 145 and projection images of data set 120. For each projection angle, a difference image (not shown) is calculated based on an image 145 corresponding to the projection angle and a projection image of data set 120 corresponding to the projection angle. These difference images represent the difference between the counts (e.g., photon counts) predicted by image object 135 and the actual counts obtained for their given projection angles.

The standard deviation of these differences of Poisson-distributed counts depends on the signal strength and therefore varies from one location in an image to another. Accordingly, CDF determination component 150 applies a cumulative distribution function to each difference image to generate CDF images 155. One known objective CDF which is well-behaved at low counts is the probability P (count≤n|m) of obtaining a Poisson count of n or less when the expected Poisson count is m. Since the probability of obtaining exactly k counts (k being a non-negative integer) is

$$P ( k ; m ) = \frac{{e}^{- m} {m}^{k}}{k !} ,$$

this CDF is given by:

$$CDF ( n \vert m ) = {\sum }_{k \leq n} \frac{{e}^{- m} {m}^{k}}{k !}$$

The Poisson cumulative distribution function described above is an example, and embodiments may use any suitable cumulative distribution function to generate CDF images 155.

Each data pixel i in a slice (e.g., a two-dimensional slice) of image data has an associated predicted count mᵢ and an observed count nᵢ. The working hypothesis is that nᵢ is a random Poisson realization of mᵢ. If this hypothesis is correct, the distribution of the CDF values pᵢ of the pixels (for various i) will be homogeneously distributed on [0,1] and will be independent from one pixel to the next, i.e., there will be no positional correlation of the values pᵢ.

Since Poisson counts can only take on integer values, the CDF is piecewise constant with discontinuities at integer points. At the discontinuities, the CDF is bracketed between a lower bound and an upper bound but is otherwise undetermined. To avoid this ambiguity, CDF determination component 150 may add a random component at the discontinuities to provide modified Poisson CDF (MCDF) images 155, where

$$MCDF ( n \vert m ) = CDF ( n \vert m ) + [ CDF ( n + 1 \vert m ) - CDF ( n \vert m ) ] * RANDOMU ( seed ) ,$$

where RANDOMU is a uniform random distribution on the interval [0,1] and seed is a seed value provided to a pseudorandom number generator implementing RANDOMU.

Under the null hypothesis of a correct data model, the MCDF is a continuous homogeneous distribution function, distributed on the interval [0,1]. Also, because the random numbers are chosen independently in each pixel from the uniform distribution in the interval [0,1], the MCDF exhibits no correlation among (i.e., between) pixels under the null hypothesis. Violations of the null hypothesis are manifested in the form of statistically-significant projected correlations and/or inhomogeneous distribution on the interval [0,1].

In some embodiments, CDF determination component 150 subtracts the mean pixel value of each CDF image from its image pixel values and then normalizes the pixel values to unit variance prior to outputting CDF images 155. If CDF images 155 are MCDF images, the mean is 0.5 because the MCDF is homogeneously distributed on the interval [0,1] under the null hypothesis.

Mismatch determination component 160 determines pixels of each of CDF images 155 which represent mismatches between data set 120 and the underlying data model of image object 135. For each of CDF images 155, mismatch determination component 160 may identify pixels having values which vary from the mean by greater than a given value. The given value may be a percentage of the mean, a predetermined constant, or any other suitable value.

According to some embodiments, mismatch determination component 160 identifies “peaks” and “valleys” within each of CDF images 155. Peaks may represent areas of a CDF image 155 in which the values of adjacent pixels increase to a local maximum, while valleys may represent areas of a CDF image 155 in which the values of adjacent pixels decrease to a local minimum. Mismatch determination component 160 may further identify pixels within each peak area having values greater than the mean pixel value of the peak area as being associated with peak areas and pixels within each valley area having values less than the mean pixel value of the valley area as associated with valley areas. Embodiments may employ any other suitable algorithms to identify pixels associated with peak areas and pixels associated with valley areas.

Mismatch determination component 160 outputs, for each of images 155, locations of pixels representing data/data model mismatches. Each location may be accompanied by a pixel value, but embodiments are not limited thereto. The locations and pixel values may be used to generate mismatch images 165. For example, in a given mismatch image 165, pixels which were not identified by mismatch determination component are set to a first value, pixels which were identified as associated with peak areas are set to a second value, and pixels which were identified as associated with valley areas are set to a third value.

Combination component 170 combines each of mismatch images 165 with a projection image of data set 120 corresponding to the same projection angle. The combination may comprise overlaying each mismatch image 165 over its corresponding projection image to generate combined images 175. In some embodiments, pixels of a combined image 175 which are associated with peak areas in the constituent mismatch image 165 are set to a first color and pixels which were identified as associated with valley areas are set to a second color.

Display 180 displays combined images 175. Two or more of combined images 175 may be displayed simultaneously. In some embodiments, combined images 175 are displayed in carousel-fashion, in which each image 175 is displayed in succession in increasing (or decreasing) order of their associated projection angles.

Displayed combined images 175 facilitate a user's understanding of how the reconstruction and corrective algorithms used to generate image object 135 changed the underlying data model. For example, combined images 175 may illustrate how the actually-acquired data was corrected by showing, in data space, where the acquired data and the data model differ.

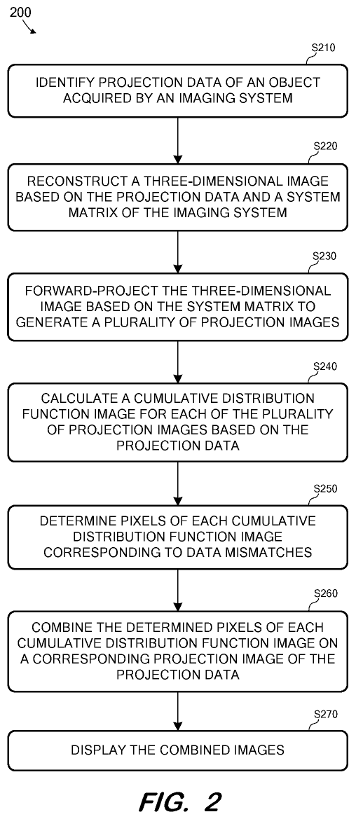

FIG. 2 is a flow diagram of process 200 to determine and present quantitative mismatches between an acquired data set and a data model according to some embodiments. In some embodiments, various hardware elements (e.g., one or more processing units such as one or more processors, one or more processor cores and one or more processor threads) execute program code to perform process 200. The steps of process 200 need not be performed by a single device or system, nor temporally adjacent to one another or necessarily in the order shown.

Process 200 and all other processes mentioned herein may be embodied in executable program code read from one or more of non-transitory computer-readable media, such as a disk-based or solid-state hard drive, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

S210 includes identification of projection data of an object acquired by an imaging system. S210 may include acquisition of the projection data by the imaging system. In other embodiments, the projection data was previously acquired by the imaging system and is identified or otherwise obtained at S210 by a physically and/or temporally-separate system.

The projection data includes profiles of acquired data per projection angle. In the case of a CT scan or a SPECT scan, the projection data includes a plurality of two-dimensional projection images, one for each of several projection angles. Each projection image in a CT scan represents detected x-ray energies within a field of view and provides information about the attenuation properties of the object being imaged. Each projection image acquired in a SPECT scan or a PET scan represents detected photon counts over the field of view and provides information regarding radiotracer distribution throughout the object. Although a PET scan does not directly generate two-dimensional projection images per se, photon count profiles per projection angle can be generated by mapping and sorting acquired PET detector pair events.

A three-dimensional image is reconstructed at S220 based on the projection data and a system matrix of the imaging system. S220 may comprise application of iterative reconstruction algorithm to the projection data as is known in the art. The three-dimensional image is forward projected based on the system matrix at S230 to generate a plurality of projection images. Each of the projection images represents a forward-projection of the three-dimensional image at a particular projection angle. As mentioned above, the projection images are in data space and represent a data model underlying the three-dimensional image.

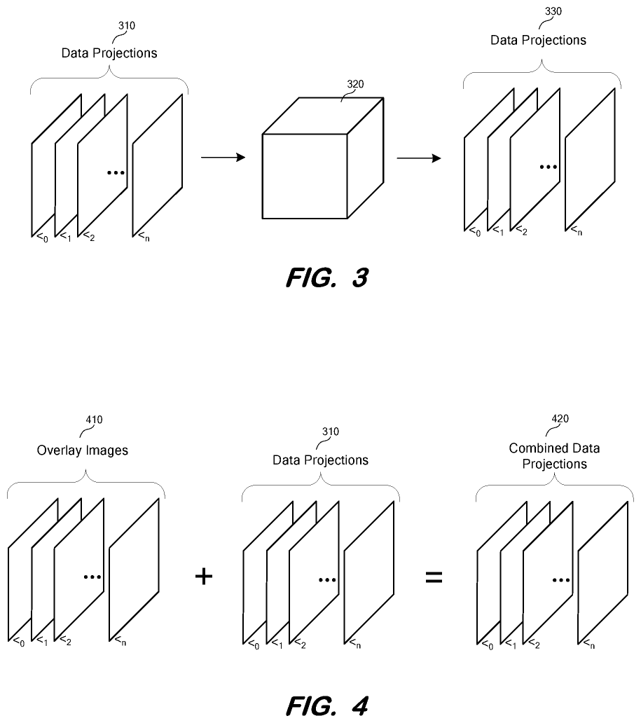

FIG. 3 illustrates a portion of process 200 according to some embodiments. Data projections 310 represent the projection data acquired at S210. As illustrated, three-dimensional image object 320 is reconstructed from data projections 310 at S220. Next, image 320 is forward-projected at various projection angles at S230, resulting in data projections 330.

Returning to process 200, a cumulative distribution function image is calculated for each of the plurality of projection images based on the projection data at S240. S240 may include identifying a projection image generated at S230 and an acquired projection image which correspond to a same projection angle. A difference image is determined based on the difference between the generated projection image and the acquired projection image. Next, a cumulative distribution function is applied to the difference image to generate a cumulative distribution function image for the projection angle. The cumulative distribution function may comprise the above-described CDF, MCDF, or any other suitable cumulative distribution function.

In a case that no mismatch exists between the generated projection image and the acquired projection image, the difference image is a null image and the cumulative distribution function image is white noise. If a mismatch exists, values certain pixels of the cumulative distribution function image may vary non-randomly from the mean. These pixels, which correspond to data mismatches, are determined for each cumulative distribution function image at S250.

Determination of the pixels may include identification of pixels of the cumulative distribution function image having values which differ from an overall mean of the cumulative distribution function image by greater than a given value or percentage. In some embodiments, S250 includes identification of pixels within peak areas in which the local mean exceeds the overall mean by a certain amount and valley areas in which the overall mean exceeds the local mean by a certain amount. S250 may further include determination of certain pixels within the peak areas and the valley areas which differ from the local mean by a certain amount.

At S260, the pixels determined at S250 for each cumulative distribution function image are combined with a corresponding projection image of the acquired projection data. FIG. 4 illustrates overlay images 410, each of which corresponds to a projection angle and represents the determined pixels of a cumulative distribution function image corresponding to the same projection angle. Overlay images 410 are combined with data projections 310 to generate combined data projections 420. In particular, an overlay image 410 associated with a particular projection angle is combined with a data projection 310 associated with the particular projection angle to generate a combined data projection 420 associated with the particular projection angle. The “plus” operator shown in FIG. 4 is intended to illustrate a generic combination operation and not necessarily an additive operation.

The pixels may be combined in any suitable manner. In one example, the pixels associated with peak areas are assigned a first color and the pixels associated with valley areas are assigned a second color. Combination at S260 may include replacing the correspondingly-located pixels of the acquired projection data with pixels of these colors.

The combined images are displayed at S270. In some embodiments, two or more combined images may be displayed simultaneously. One or more combined images may be displayed in succession at S270 as described above.

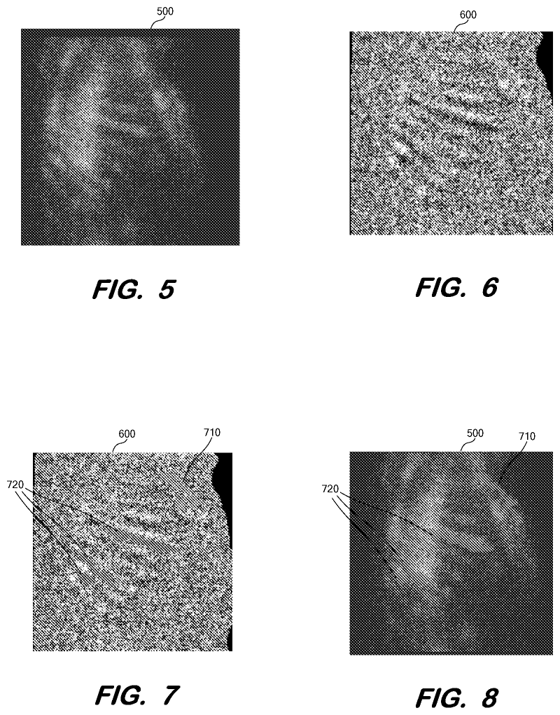

FIGS. 5 through 8 illustrate an example according to some embodiments. Projection image 500 represents data acquired by an imaging system at a particular projection angle. Projection image 500 is in data space as described above.

FIG. 6 is a view of MCDF image 600 determined based on acquired projection image 500 and a corresponding data projection as described above. More specifically, a three-dimensional image is reconstructed based on acquired projection image 500 and other projection images acquired from different projection angles. The three-dimensional image is forward-projected at the projection angle of image 500 to generate a data projection. MCDF image 600 is calculated based on the difference between the generated data projection and image 500.

FIG. 7 is a view showing pixels 710 associated with peaks of MCDF image 600 and pixels 720 associated with valleys of MCDF image 600. Pixels 710 and 720 may comprise an overlay image and may therefore be assigned colors, patterns, or any other characteristic which may distinguish the pixels from pixels of image 500. In this regard, FIG. 8 is a view of a combination of acquired data projection 500 and an overlay image consisting of pixels 710 and 720.

The combined image of FIG. 8 may thereby present to a user, in data space, locations where the acquired data and the data model underlying the reconstructed image object differ. The process illustrated by FIGS. 5 through 8 may occur for each other projection angle of the acquired data, further facilitating the user's understanding of the mismatches.

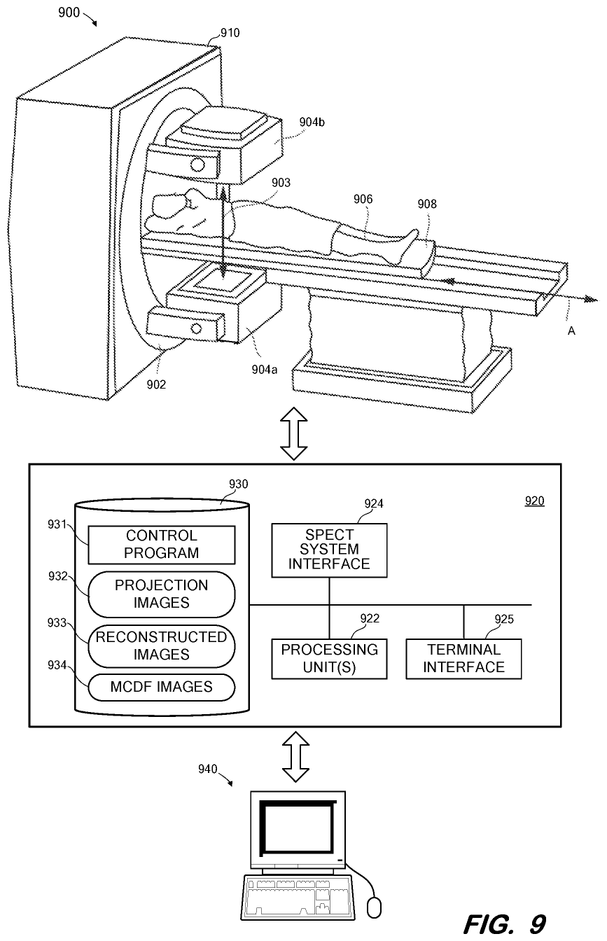

FIG. 9 illustrates imaging system 900 according to some embodiments. System 900 is a SPECT imaging system as is known in the art, but embodiments are not limited thereto. Each component of system 900 may include other elements which are necessary for the operation thereof, as well as additional elements for providing functions other than those described herein.

System 900 includes gantry 902 supported in a housing 910 to which two or more gamma cameras 904a, 904b are attached, although any number of gamma cameras can be used. A detector within each gamma camera detects gamma photons (i.e., emission data) 903 emitted by a radioactive tracer injected into the body of patient 906 lying on bed 908. Bed 908 is slidable along axis-of-motion A. At respective bed positions (i.e., imaging positions), a portion of the body of patient 906 is positioned between gamma cameras 904a, 904b in order to capture emission data from that body portion from various projection angles.

Control system 920 may comprise any general-purpose or dedicated computing system. Control system 920 includes one or more processing units 922 configured to execute executable program code to cause system 920 to operate as described herein, and storage device 930 for storing the program code. Storage device 930 may comprise one or more fixed disks, solid-state random access memory, and/or removable media (e.g., a thumb drive) mounted in a corresponding interface (e.g., a USB port).

Storage device 930 stores program code of control program 931. One or more processing units 922 may execute control program 931 to, in conjunction with SPECT system interface 924, control motors, servos, and encoders to cause gamma cameras 904a, 904b to rotate along gantry 902 and to acquire two-dimensional projection images 932 at defined projection angles during the rotation.

Control program 931 may further be executed to reconstruct images 933 based on projection images 932. Moreover, MCDF images 934 may be determined based on projection images 932 and reconstructed images 933 as described above.

Terminal 940 may comprise a display device and an input device coupled to system 920 through the terminal interface 925. Terminal 940 may receive projection images 932, reconstructed images 933, and combined images which combine pixels of MCDF images 934 with corresponding projection images 932. In some embodiments, terminal 940 is a separate computing device such as, but not limited to, a desktop computer, a laptop computer, a tablet computer, and a smartphone.

Those in the art will appreciate that various adaptations and modifications of the above-described embodiments can be configured without departing from the claims. Therefore, it is to be understood that the claims may be practiced other than as specifically described herein.

What is claimed is:

1. A method comprising:
identifying a first plurality of projection images of an object acquired by an imaging system, each of the first plurality of projection images associated with a respective one of a plurality of projection angles;
reconstructing a three-dimensional image of the object based on the first plurality of projection images;
forward-projecting the three-dimensional image at the plurality of projection angles to generate a second plurality of projection images, each of the second plurality of projection images associated with a respective one of the plurality of projection angles;
determining a first cumulative distribution function image for a first one of the plurality of projection angles based on a difference between a first one of the first plurality of projection images associated with the first one of the plurality of projection angles and a second one of the second plurality of projection images associated with the first one of the plurality of projection angles;
determining pixels of the first cumulative distribution function image corresponding to differences between the first one of the first plurality of projection images and the second one of the second plurality of projection images;
combining the determined pixels of the first cumulative distribution function image with the first one of the first plurality of projection images to generate a first combined image; and
displaying the first combined image.

2. A method according to claim 1, further comprising:
determining a second cumulative distribution function image for a second one of the plurality of projection angles based on a difference between a third one of the first plurality of projection images associated with the second one of the plurality of projection angles and a fourth one of the second plurality of projection images associated with the second one of the plurality of projection angles;
determining pixels of the second cumulative distribution function image corresponding to differences between the third one of the first plurality of projection images and the fourth one of the second plurality of projection images;
combining the determined pixels of the second cumulative distribution function image with the third one of the first plurality of projection images to generate a second combined image; and
displaying the second combined image.

3. A method according to claim 1, wherein the three-dimensional image of the object is reconstructed based on the first plurality of projection images and a system matrix of the imaging system, and
wherein the three-dimensional image is forward-projected based on the system matrix of the imaging system.

4. A method according to claim 1, wherein determining the first cumulative distribution function image comprises:
determining a difference image based on the first one of the first plurality of projection images and the second one of the second plurality of projection images; and
applying a cumulative distribution function to the difference image.

5. A method according to claim 4, wherein the cumulative distribution function comprises a Poisson cumulative distribution function.

6. A method according to claim 1, wherein combining the determined pixels of the first cumulative distribution function image with the first one of the first plurality of projection images comprises overlaying the determined pixels on the first cumulative distribution function image.

7. A method according to claim 6, wherein overlaid determined pixels corresponding to positive differences are displayed in a first color and overlaid determined pixels corresponding to negative differences are displayed in a second color.

8. A system comprising:
an imaging system to acquire a first plurality of projection images of an object, each of the first plurality of projection images acquired at a respective one of a plurality of projection angles;
a processing unit to:
reconstruct a three-dimensional image of the object based on the first plurality of projection images;
forward-project the three-dimensional image at the plurality of projection angles to generate a second plurality of projection images, each of the second plurality of projection images associated with a respective one of the plurality of projection angles;
determine a first cumulative distribution function image for a first one of the plurality of projection angles based on a difference between a first one of the first plurality of projection images associated with the first one of the plurality of projection angles and a second one of the second plurality of projection images associated with the first one of the plurality of projection angles;
determine pixels of the first cumulative distribution function image corresponding to differences between the first one of the first plurality of projection images and the second one of the second plurality of projection images; and
combining the determined pixels of the first cumulative distribution function image with the first one of the first plurality of projection images to generate a first combined image; and
a display to display the first combined image.

9. A system according to claim 8, the processing unit to:
determine a second cumulative distribution function image for a second one of the plurality of projection angles based on a difference between a third one of the first plurality of projection images associated with the second one of the plurality of projection angles and a fourth one of the second plurality of projection images associated with the second one of the plurality of projection angles;
determine pixels of the second cumulative distribution function image corresponding to differences between the third one of the first plurality of projection images and the fourth one of the second plurality of projection images; and
combine the determined pixels of the second cumulative distribution function image with the third one of the first plurality of projection images to generate a second combined image, and
the display to display the second combined image.

10. A system according to claim 8, wherein the three-dimensional image of the object is reconstructed based on the first plurality of projection images and a system matrix of the imaging system, and
wherein the three-dimensional image is forward-projected based on the system matrix of the imaging system.

11. A system according to claim 8, wherein determination of the first cumulative distribution function image comprises:
determination of a difference image based on the first one of the first plurality of projection images and the second one of the second plurality of projection images; and
application of a cumulative distribution function to the difference image.

12. A system according to claim 11, wherein the cumulative distribution function comprises a Poisson cumulative distribution function.

13. A system according to claim 8, wherein combination of the determined pixels of the first cumulative distribution function image with the first one of the first plurality of projection images comprises overlay of the determined pixels on the first cumulative distribution function image.

14. A system according to claim 13, wherein overlaid determined pixels corresponding to positive differences are displayed in a first color and overlaid determined pixels corresponding to negative differences are displayed in a second color.

15. A non-transitory computer-readable medium storing program code executable by a processing unit to:
identify a first plurality of projection images of an object acquired by an imaging system, each of the first plurality of projection images associated with a respective one of a plurality of projection angles;
reconstruct a three-dimensional image of the object based on the first plurality of projection images;
forward-project the three-dimensional image at the plurality of projection angles to generate a second plurality of projection images, each of the second plurality of projection images associated with a respective one of the plurality of projection angles;
determine a first cumulative distribution function image for a first one of the plurality of projection angles based on a difference between a first one of the first plurality of projection images associated with the first one of the plurality of projection angles and a second one of the second plurality of projection images associated with the first one of the plurality of projection angles;
determine pixels of the first cumulative distribution function image corresponding to differences between the first one of the first plurality of projection images and the second one of the second plurality of projection images;
combine the determined pixels of the first cumulative distribution function image with the first one of the first plurality of projection images to generate a first combined image; and
display the first combined image.

16. A medium according to claim 15, the program code executable by a processing unit to:
determine a second cumulative distribution function image for a second one of the plurality of projection angles based on a difference between a third one of the first plurality of projection images associated with the second one of the plurality of projection angles and a fourth one of the second plurality of projection images associated with the second one of the plurality of projection angles;
determine pixels of the second cumulative distribution function image corresponding to differences between the third one of the first plurality of projection images and the fourth one of the second plurality of projection images;
combine the determined pixels of the second cumulative distribution function image with the third one of the first plurality of projection images to generate a second combined image; and
display the second combined image.

17. A medium according to claim 15, wherein the three-dimensional image of the object is reconstructed based on the first plurality of projection images and a system matrix of the imaging system, and
wherein the three-dimensional image is forward-projected based on the system matrix of the imaging system.

18. A medium according to claim 15, wherein determination of the first cumulative distribution function image comprises:
determination of a difference image based on the first one of the first plurality of projection images and the second one of the second plurality of projection images; and
application of a cumulative distribution function to the difference image.

19. A medium according to claim 15, wherein combination of the determined pixels of the first cumulative distribution function image with the first one of the first plurality of projection images comprises overlay of the determined pixels on the first cumulative distribution function image.

20. A medium according to claim 16, wherein overlaid determined pixels corresponding to positive differences are displayed in a first color and overlaid determined pixels corresponding to negative differences are displayed in a second color.
